(19) United States
(12) Patent Application Publication
(10) Pub. No.: US 2017/0017451 A1
(43) Pub. Date: Jan. 19, 2017

(54) METHOD AND SYSTEM FOR MANAGING APPLICATIONS RUNNING ON SMART DEVICE USING A WEARABLE DEVICE

(71) Applicant: Samsung Electronics Co., Ltd., Suwon-si (KR)

(72) Inventors: Nandan SATHYANARAYANA RAGHU, Bengaluru (IN); Sanjay Kumar AGARWAL, Jharkhand (IN); Karthik PAULRAJ, Chennai (IN); Asha VEERABHADRAIAH, Bengaluru (IN); Mukunth ASOKAN, Neyveli (IN)

(21) Appl. No.: 15/211,605

(22) Filed: Jul. 15, 2016

(30) Foreign Application Priority Data
Jul. 17, 2015 (IN) 3681/CHE/2015
Jul. 11, 2016 (KR) 10-2016-0087492

(51) Int. Cl. G06F 3/14; G06F 3/0482; G06F 3/0488; H04B 1/3827; G06F 1/16; H04N 21/643; H04L 12/58; H04N 21/431; G06F 3/0481; G06F 3/0484

(52) U.S. Cl. CPC G06F 3/14; G06F 3/04817; G06F 3/0482; G06F 3/04883; G06F 3/04845; G06F 1/163; H04N 21/64322; H04L 51/22; H04N 21/4312; H04B 1/385; G06F 2203/04808; G06F 2203/04806; G06F 2203/04803

(57) ABSTRACT

A method and a system for managing applications running on one or more smart devices are provided. The method includes displaying a plurality of application icons on a wearable device, wherein each icon from the plurality of application icons represents an active application on the smart device connected to the wearable device, receiving a touch gesture on one or more application icons from the plurality of icons, and triggering the smart device to perform an event comprising an interaction between the active applications represented by the one or more application icons in response to the touch gesture.

### CROSS-REFERENCE TO RELATED APPLICATION(S)

This application claims the benefit under 35 U.S.C. §119(a) of an Indian patent application filed on Jul. 17, 2015 in the Indian Patent Office and assigned Serial number 3681/CHE/2015, and of a Korean patent application filed on Jul. 11, 2016 in the Korean Intellectual Property Office and assigned Serial number 10-2016-0087492, the entire disclosure of each of which is hereby incorporated by reference.

### TECHNICAL FIELD

The present disclosure relates to a wearable device. More particularly, the present disclosure relates to a method and a system for managing applications running on smart device using the wearable device.

### BACKGROUND

Wearable device, such as a smartwatch is a computerized wristwatch having enhanced function beyond timekeeping whereas the existing smartwatch performs basic functions, such as calculations, translations, and game-playing. Now, we are surrounded with number of smart devices and managing these devices individually is a cumbersome process. However, controlling the smart devices with the wearable devices is known for limited functions.

Present state of the art does not provide for ways to enable a user to prioritize one or more applications or/and handle multiple applications running in a smart device though a wearable device, where the user could prioritize one or more applications or/and handle multiple applications by interacting with the wearable device. Generally smart devices include, but not limited to, a smartphone, a tablet and a smart television (TV). The smart device, such as a smartphone, runs various applications, such as social network services (SNSs), emails, and instant messaging (IM) applications.

Additionally, there is no system having interactive user experience (UX) to control and manage multiple programs simultaneously in smart devices.

Therefore, there is a need for a method and a system for managing multiple smart devices by controlling the programs or applications running on a smart device using a wearable device.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide a method and a system for managing applications running on smart device using a wearable device.

In accordance with an aspect of the present disclosure, a method for managing applications running on one or more smart devices is provided. The method includes displaying a plurality of application icons on a wearable device, wherein each icon from the plurality of application icons represents an active application on the smart device connected to the wearable device, receiving a touch gesture on one or more application icons from the plurality of icons, and triggering the smart device to perform an event comprising an interaction between the active applications represented by the one or more application icons in response to the touch gesture.

In accordance with another aspect of the present disclosure, a wearable device is provided. The wearable device includes a memory that is configured to store computer-executable instructions, and one or more processors communicatively coupled to the memory. The one or more processors are configured to execute the computer-executable instructions stored in the memory to display a plurality of application icons on the wearable device, wherein each icon from the plurality of application icons represents an active application on a smart device connected to the wearable device, receive a touch gesture on one or more application icons from the plurality of icons, and transmit an instruction to the smart device to perform an event comprising an interaction between the active applications represented by the one or more application icons in response to the touch gesture.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 illustrates a system for managing communication between a smart device and a wearable device according to an embodiment of the present disclosure;

FIG. 2 illustrates a scenario of switching between an application mode and a priority mode of a control user experience (UX) application running on a wearable device on receiving a predefined gesture according to an embodiment of the present disclosure;

FIG. 3 illustrates a scenario of handling an incoming call on a smart device on receiving a predefined gesture on a wearable device according to an embodiment of the present disclosure;

FIGS. 4A and 4B illustrate a scenario of merging two or more incoming calls and converting into a conference call on receiving a predefined gesture on a wearable device according to an embodiment of the present disclosure;

FIG. 5 illustrates a scenario of sharing a smartphone screen between two applications on receiving a predefined gesture on a wearable device according to an embodiment of the present disclosure;

FIG. 6 illustrates a scenario of merging multiple browsers in a smart device, such as a tablet on receiving a predefined gesture on a wearable device, according to an embodiment of the present disclosure;

FIG. 7 illustrates a scenario of merging multiple browsers in a smart device, such as smartphones on receiving a predefined gesture on a wearable device, according to an embodiment of the present disclosure;

FIGS. 8A and 8B illustrate a scenario of transmitting a memo as an email attachment on receiving a predefined gesture on a wearable device according to an embodiment of the present disclosure;

FIG. 9 illustrates a scenario of closing one or more applications on receiving a predefined gesture on a wearable device according to an embodiment of the present disclosure;

FIG. 10 illustrates a scenario of performing content based searching in a smart device on receiving a predefined gesture on a wearable device according to an embodiment of the present disclosure;

FIG. 11 illustrates a scenario of controlling key feature of an application in a smart device on receiving a predefined gesture on a wearable device according to an embodiment of the present disclosure;

FIG. 12 illustrates a scenario of swapping two programs in smart television (TV) on receiving a predefined gesture on a wearable device according to an embodiment of the present disclosure;

FIGS. 13A and 13B illustrate a scenario of sharing a display screen among multiple TV channels on receiving a predefined gesture on a wearable device according to an embodiment of the present disclosure;

FIG. 14 illustrates a scenario of defining a specific setting for each channel using a wearable device according to an embodiment of the present disclosure;

FIG. 15 illustrates an electronic device within a network environment according to various embodiments of the present disclosure; and

FIG. 16 is a block diagram of an electronic device according to various embodiments of the present disclosure.

Throughout the drawings, like reference numerals will be understood to refer to like parts, components, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

The expressions, such as “include” and “may include” which may be used in an embodiment of the present disclosure denote the presence of the disclosed functions, operations, and constituent elements and do not limit one or more additional functions, operations, and constituent elements. In an embodiment of the present disclosure, the terms, such as “include” and/or “have” may be construed to denote a certain characteristic, number, operation, constituent element, component or a combination thereof, but may not be construed to exclude the existence of or a possibility of addition of one or more other characteristics, numbers, operations, constituent elements, components or combinations thereof.

Furthermore, in an embodiment of the present disclosure, the expression “and/or” includes any and all combinations of the associated listed words. For example, the expression “A and/or B” may include A, may include B, or may include both A and B.

In an embodiment of the present disclosure, expressions including ordinal numbers, such as “first” and “second,” and the like, may modify various elements. However, such elements are not limited by the above expressions. For example, the above expressions do not limit the sequence and/or importance of the elements. The above expressions are used merely for the purpose to distinguish an element from the other elements. For example, a first user device and a second user device indicate different user devices although both of them are user devices. For example, a first element could be termed a second element, and similarly, a second element could be also termed a first element without departing from the scope of the present disclosure.

In the case where a component is referred to as being “connected” or “accessed” to other component, it should be understood that not only the component is directly connected or accessed to the other component, but also there may exist another component between them. Meanwhile, in the case where a component is referred to as being “directly connected” or “directly accessed” to other component, it should be understood that there is no component therebetween.

An electronic device according to the present disclosure may be a device including a communication function. For example, the device corresponds to a combination of at least one of a smartphone, a tablet personal computer (PC), a mobile phone, a video phone, an e-book reader, a desktop PC, a laptop PC, a netbook computer, a personal digital assistant (PDA), a portable multimedia player (PMP), a digital audio player, a mobile medical device, an electronic bracelet, an electronic necklace, an electronic accessory, a camera, a wearable device, an electronic clock, a wrist watch, home appliances (for example, an air-conditioner, vacuum, an oven, a microwave, a washing machine, an air cleaner, and the like), an artificial intelligence robot, a television (TV), a digital versatile disc (DVD) player, an audio device, various medical devices (for example, magnetic resonance angiography (MRA), magnetic resonance imaging (MRI), computed tomography (CT), a scanning machine, a ultrasonic wave device, and the like), a navigation device, a global positioning system (GPS) receiver, an event data recorder (EDR), a flight data recorder (FDR), a set-top box, a TV box (for example, Samsung HomeSync™, Apple TV™, or Google TV™), an electronic dictionary, vehicle infotainment device, an electronic equipment for a ship (for example, navigation equipment for a ship, gyrocompass, and the like), avionics, a security device, electronic clothes, an electronic key, a camcorder, game consoles, a head-mounted display (HMD), a flat panel display device, an electronic frame, an electronic album, furniture or a portion of a building/structure that includes a communication function, an electronic board, an electronic signature receiving device, a projector, and the like. It is obvious to those skilled in the art that the electronic device according to the present disclosure is not limited to the aforementioned devices.

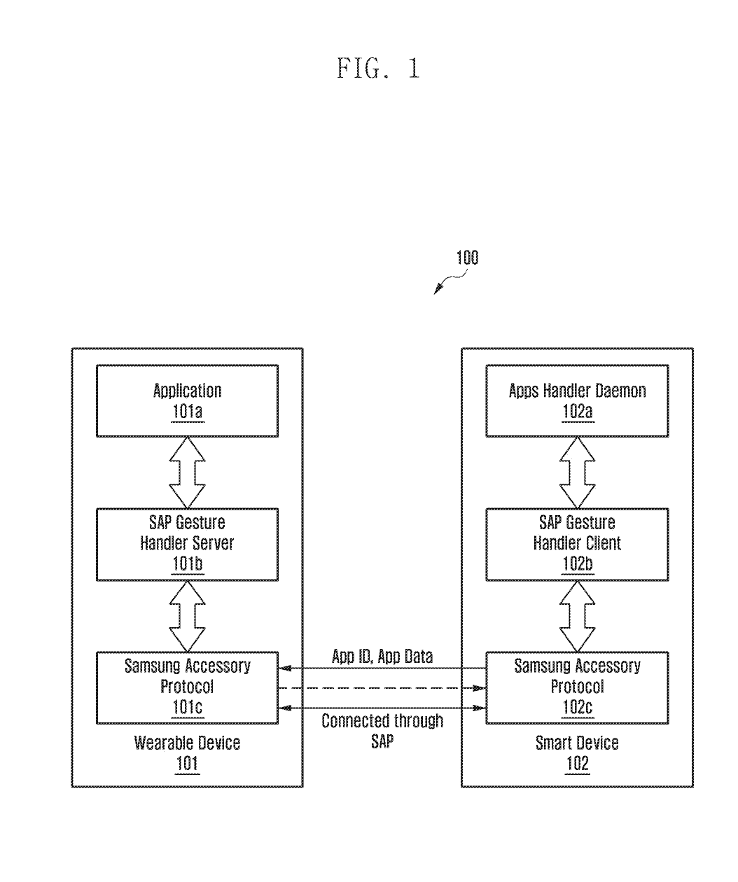

FIG. 1 illustrates a system for managing communication between a smart device and a wearable device according to an embodiment of the present disclosure.

Referring to FIG. 1, a system 100 comprises a wearable device 101 and one or more smart devices 102. The smart device 102 includes but not limited to a smart phone, a tablet, a smart TV, and the like. The wearable device 101 comprises an application module 101a, a Samsung accessory protocol (SAP) gesture handler server 101b, and accessory protocols 101c. The smart device 102 comprises an application handler daemon 102a, an SAP gesture handler client 102b, and accessory protocols 102c.

For example, the connection between the wearable device 101 and the smart device 102 is established through an SAP (or any wireless link with communication protocol). The application when launched or closed on the smart device 102, the app identifier (ID) and the app data (if any) are sent to the wearable device 101 in which the SAP gesture handler server 101b handles the data and notifies the application 101a of the wearable device 101. The data communicated from the smart device 102 to the wearable device 101 includes but not restricted to
i. Application ID
ii. Application icon details.
iii. Event type. (Launched/Closed/Background/Foreground/Priority change, and the like)
iv. Event details.
v. In case of TV it can be the channel details. (Icon+Number+Category like News, Sports, Movies, and the like)

In an embodiment of the present disclosure, the wearable device 101 comprises a memory (not shown in FIG. 1) and a processor (not shown in FIG. 1). When the application on the wearable device 101 detects a gesture, the processor of the wearable device 101 processes the gesture. Subsequently, the wearable device 101 transmits instructions to the smart device 102 for implementing the gesture. The gesture includes but not limited to Swap, Pinch, Double tap, Long press and the like. The data transmitted by the wearable device 101 includes but not limited to
Application ID/ID s
Event type. (Priority change, Foreground, Background, Close, Merge, Split screen, and the like)
Event details

In case of TV, the subset of the above mentioned events would hold good and the event details would be the settings like contrast, brightness, and the like, channel number and others.

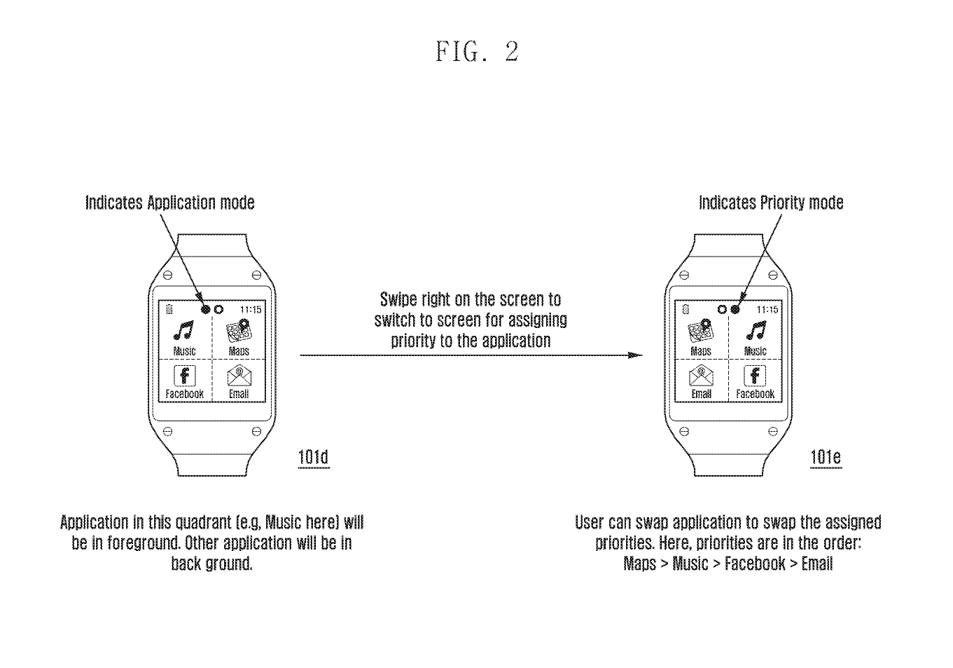

FIG. 2 illustrates a scenario of switching between an application mode and a priority mode of a control user experience (UX) application running on a wearable device on receiving a predefined gesture according to an embodiment of the present disclosure.

Referring to FIG. 2, in an embodiment of the present disclosure, the user interface (UI) is designed in such a way that with a simple UI touch gesture, the user can switch between the application mode (as shown in 101d) and the priority mode (as shown in 101e). In the application mode, the user performs the following activities:
Applications can be sent to foreground/background by a predefined gesture, such as by swiping the application icons.
Two applications can be merged depending on the predefined configuration (such as context) on receiving a predefined gesture (such as Pinch zoom in or using two fingers) to merge the applications.
Screen of the smart device can be virtually split to share between two applications on receiving a predefined gesture, such as Long press on an application icon and move it on top of another icon.
The setting of the smart TV can be changed on receiving a predefined gesture. The setting includes but not limited to brightness, volume, contrast, child security feature or any other features provided in the smart TV. In another case, the channels can be changed by providing a predefined gesture, such as swapping.
Key feature of the application can be controlled by providing a predefined gesture, such as Double tap gesture.
One or more applications can be closed by providing a predefined gesture, such as pinch zoom out.

In the priority mode, the user is allowed to change the priority of the one or more applications. The change of priority enhances the user experience by allowing him to define his own priority to the applications rather than operating system (OS) managing the priorities.

For example: user wants to give the highest priority to the camera application when the battery is low. Using the present method, it would be easy/convenient for the user to change the priority of the required application just by a predefined gesture on the wearable device.

In an embodiment of the present disclosure, the priority of the application decrease from top left quadrant clock wise to bottom left quadrant. The application in top left quadrant (is the fourth quadrant of the display screen) has the highest priority. The top left quadrant of the display screen is a first (highest) priority quadrant. The top right quadrant of the display screen is a second priority quadrant. The bottom right quadrant of the display screen is a third priority quadrant. The bottom left quadrant of the display screen is a fourth priority quadrant.

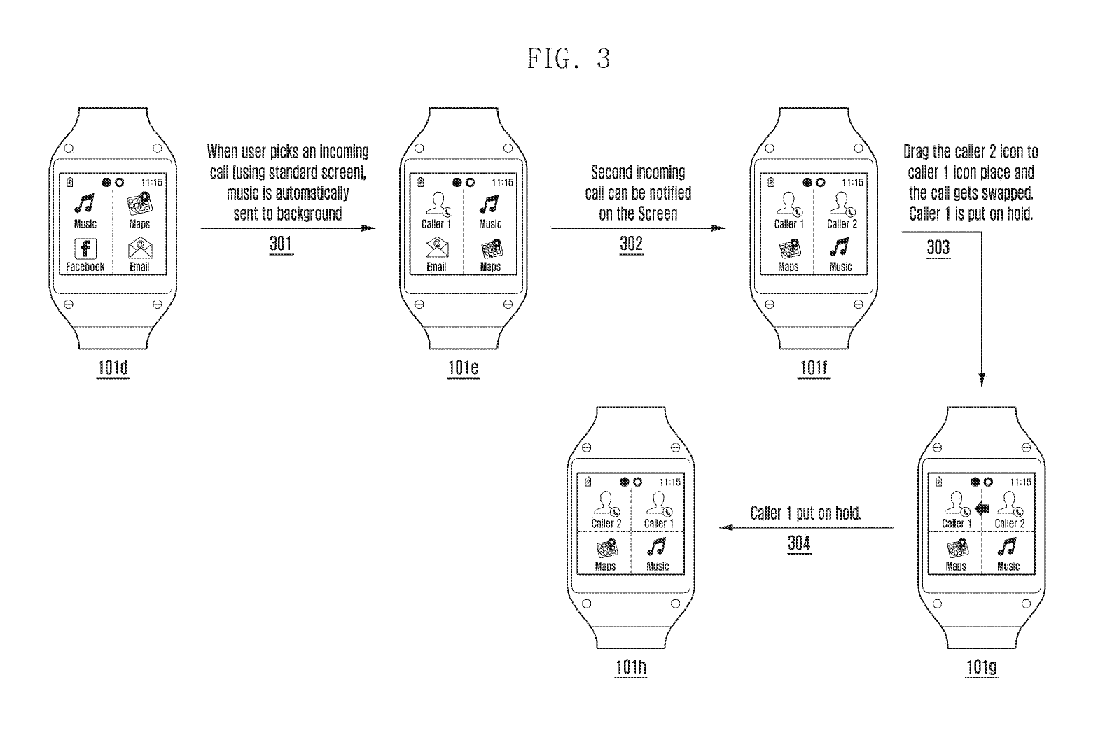

FIG. 3 illustrates a scenario of handling an incoming call on a smart device on receiving a predefined gesture on a wearable device according to an embodiment of the present disclosure.

Referring to FIG. 3, in this embodiment of the present disclosure, a music player application is in the first priority quadrant of the wearable device 101d and so has highest priority. When the user picks up an incoming call at operation 301 using any of the available methods, such as Swipe to answer the incoming call on the smart device, receive through hands free, answer via wearable device, and the like, the call application takes the highest priority and its icon moves to the first priority quadrant (or the fourth quadrant of the screen) on the screen of the wearable device (as shown in 101e).

During the first call, if another incoming call arrives at operation 302, then the second call's icon occupies a second priority quadrant (i.e., top right quadrant of the screen) to indicate that another call is waiting (as shown in 1010. In case of further subsequent incoming call, the subsequent incoming call would be placed in the next lower priority quadrant. The user can switch between the calls by using a predefined gesture, such as dragging the second call's icon to the first priority quadrant (as shown in 101g) at operation 303 which automatically places the first call on hold at operation 304 and its icon being moved to the second priority quadrant (as shown in 101h).

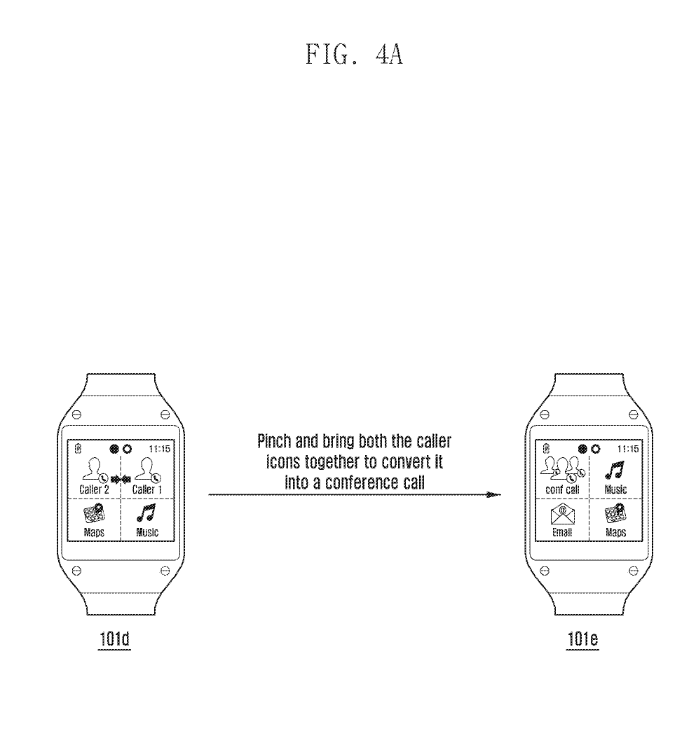

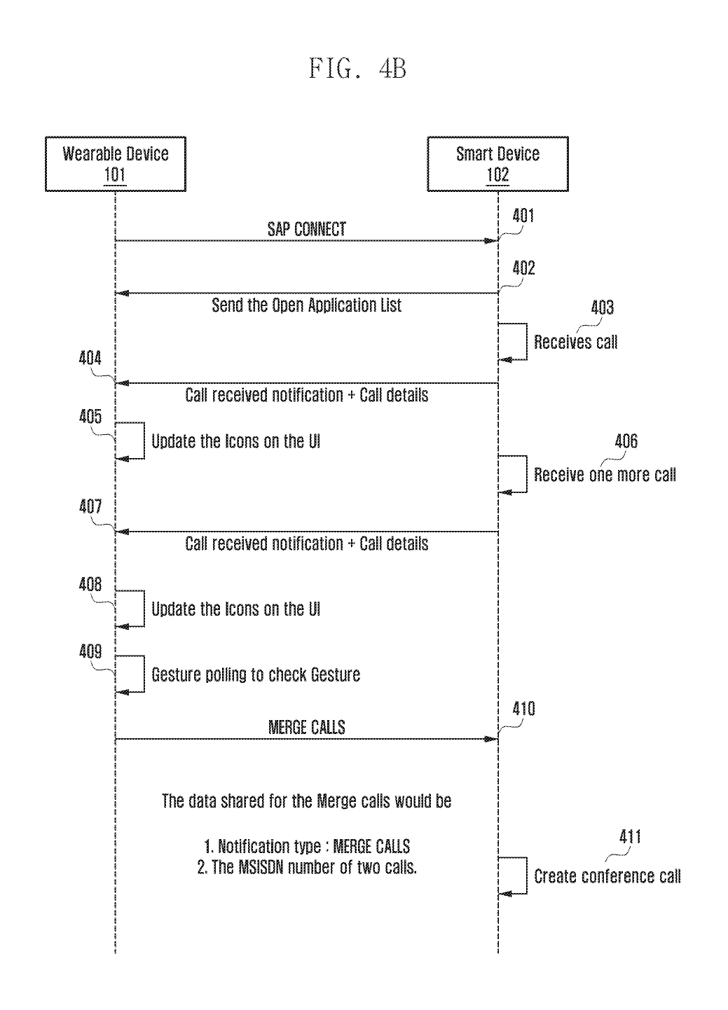

FIGS. 4A and 4B illustrate a scenario of merging two or more incoming calls and converting into a conference call on receiving a predefined gesture on a wearable device according to an embodiment of the present disclosure.

Referring to FIG. 4A, a pictorial representation of a scenario is illustrated in which one or more further incoming calls comes during the first incoming call and user converts these calls into a conference by applying a predefined gesture, such as pinching and bringing both the call icons together. This converts the existing ongoing call into a conference call and changes the icon to a conference call icon which is placed in the first priority quadrant.

Referring to FIG. 4B, a flow diagram of merging two or more incoming calls and converting into a conference call on receiving a predefined gesture on a wearable device 101 is illustrated.

At operation 401, the wearable device 101 connects to the smart device 102 (such as a smart phone or a tablet) through SAP.

At operation 402, the smart device transmits a list of applications running on it.

At operation 403, the smart device receives an incoming call.

At operation 404, the smart device 102 transmits a call received notification along with call details to the wearable device 101.

At operation 405, the wearable device 101 updates the icons on the UI of the wearable device 101.

At operation 406, the smart device 102 receives another incoming call.

At operation 407, the smart device 102 transmits another call received notification along with second call details to the wearable device 101.

At operation 408, the wearable device 101 updates the icons on the UI of the wearable device 101.

At operation 409, the wearable device 101 performs gesture polling to determine the gesture. The wearable device 101 interprets a gesture received from the user and performs the corresponding function, in this particular case changing the icon to the conference call. Here, polling is a procedure in which one process waits for the inputs from another. In this case, after receiving the call details, the wearable device waits for the user gestures. This wait is described as polling.

At operation 410, the wearable device 101 transmits the data to the smart device 102 for merging and converting the two or more calls into conference calls. The data includes but not limited to notification type (i.e., merge calls), and the mobile station international subscriber directory number (MSISDN) number of two calls.

At operation 411, the conference call is established between two or more callers.

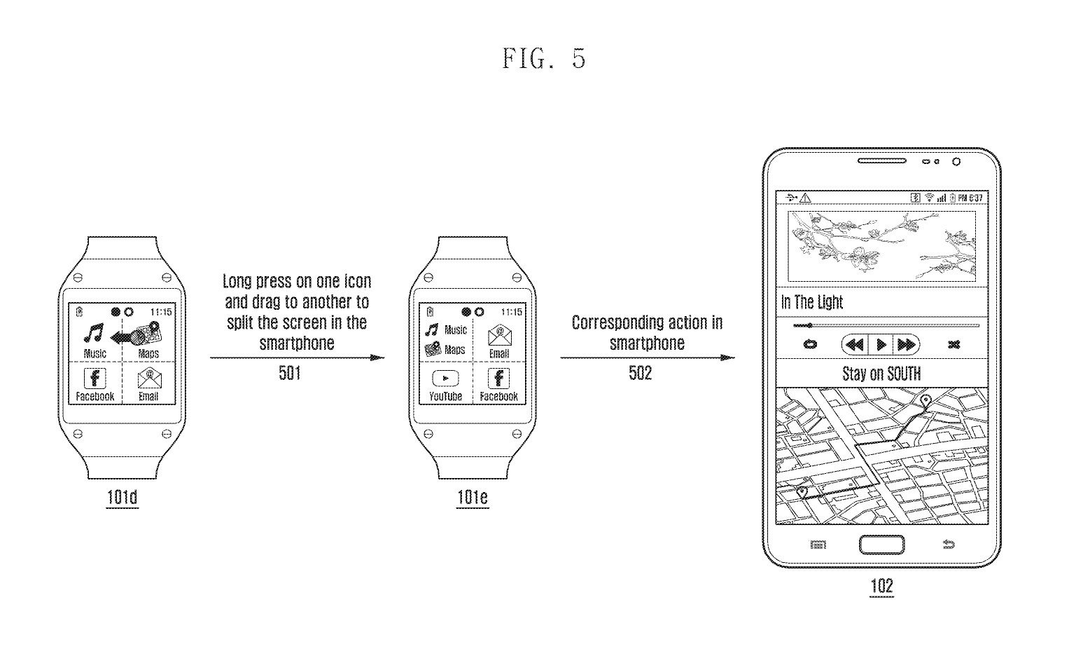

FIG. 5 illustrates a scenario of sharing a smartphone screen between two applications on receiving a predefined gesture on a wearable device according to an embodiment of the present disclosure. This embodiment explains how the user can virtually split the screen and places two different applications on one screen (Single screen).

Referring to FIG. 5, in this embodiment of the present disclosure, an icon of music application (i.e., a primary application which is in the foreground of the smart device) occupies the first priority quadrant and an icon of the map application occupies the second priority quadrant, of the screen of the wearable device 101. At operation 501, the user provides a predefined gesture on the wearable device 101 to virtually split the screen of the smart device 102. At operation 502, the wearable device 101 transmits an instruction to the smart device to virtually split the screen of the smart device and enable the user to access both the application together. This updates the icon on the wearable device 101 as well. In this particular case, the predefined gesture is a long press on the icon of the second application (new application icon which needs to be placed on the smart device screen) and drag to the first priority quadrant.

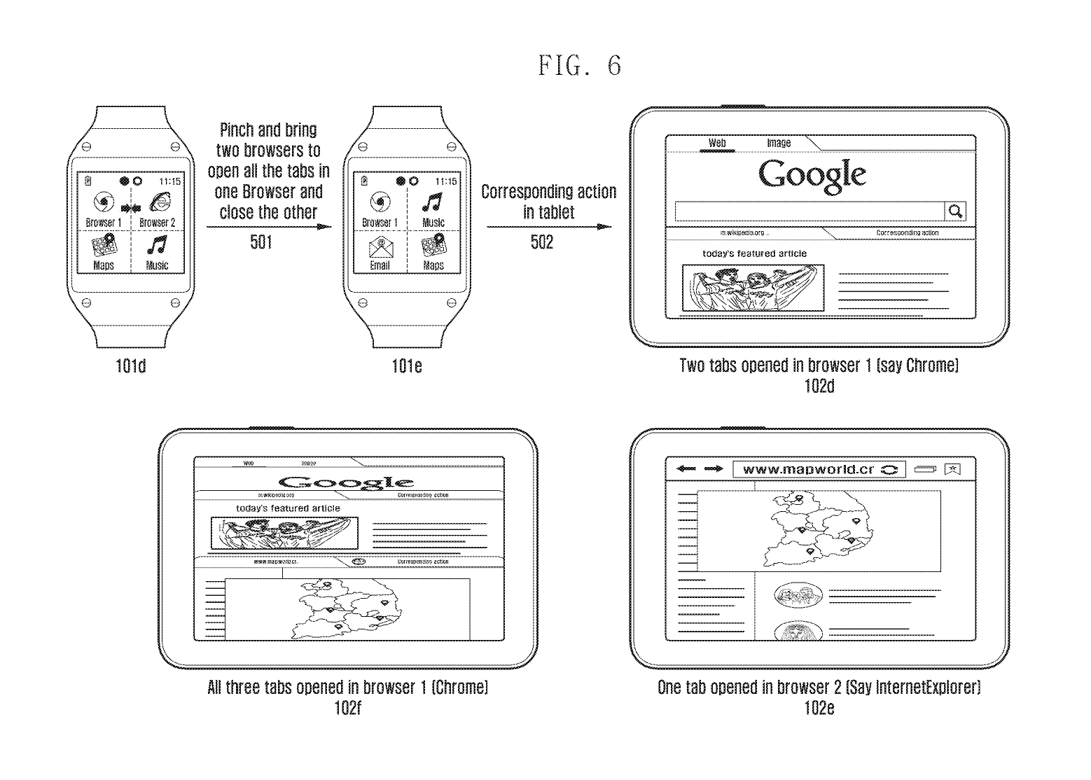

FIG. 6 illustrates a scenario of merging multiple browsers in a smart device, such as a tablet, on receiving a predefined gesture on a wearable device, according to an embodiment of the present disclosure.

Referring to FIG. 6, this embodiment describes how two applications can be merged contextually. The contextual merging of applications is a method of using a data from one application in another application. The data can be anything that is of useful to another application. There can be a pre-defined or a default behavior when the applications are merged contextually or the user can be allowed to configure how the applications should respond when they are merged contextually.

In an embodiment of the present disclosure, there are few tabs which are opened in chrome browser and there are another set of tabs that are opened in Internet Explorer. When both these applications are merged contextually (by providing a predefined gesture, such as Pinch and bring two browsers together), all the tabs present in one browser (Internet Explorer here because it has lesser priority compared to Chrome because of its placement in the UI of the wearable device), would be opened in another browser (Chrome here) and the former would be closed.

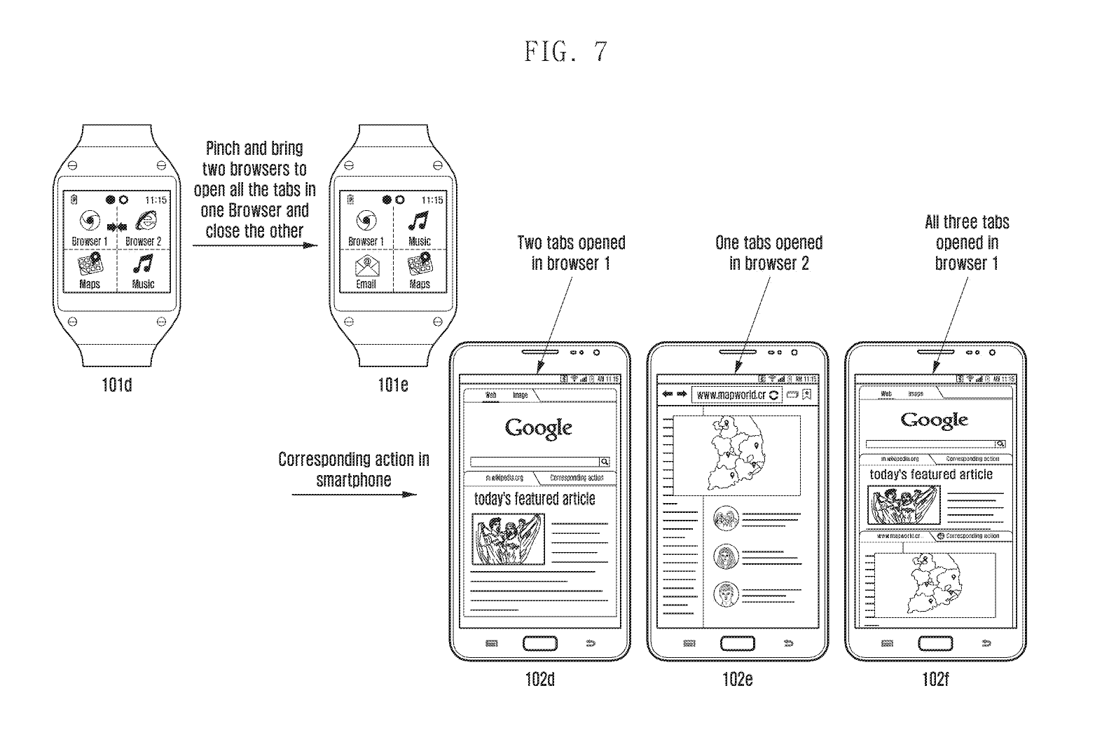

FIG. 7 illustrates a scenario of merging multiple browsers in a smart device, such as smartphones on receiving a predefined gesture on a wearable device, according to an embodiment of the present disclosure.

Referring to FIG. 7, this embodiment also describes contextual merging of two applications similar to the embodiment described in FIG. 6 but in this embodiment the smart device is a smart phone. In the smart device 102d, two tabs are opened in one browser. In the smart device 102e, one tab is opened in another browser. When the UI of the wearable device receives a predefined gesture (such as pinching and bringing two browsers), the wearable device 101 process the received gesture and transmits the instruction to the smart device 102. The smart device (i.e., a smart phone) 102 opens all the tabs in one browser and closes the other browser as shown in 102f.

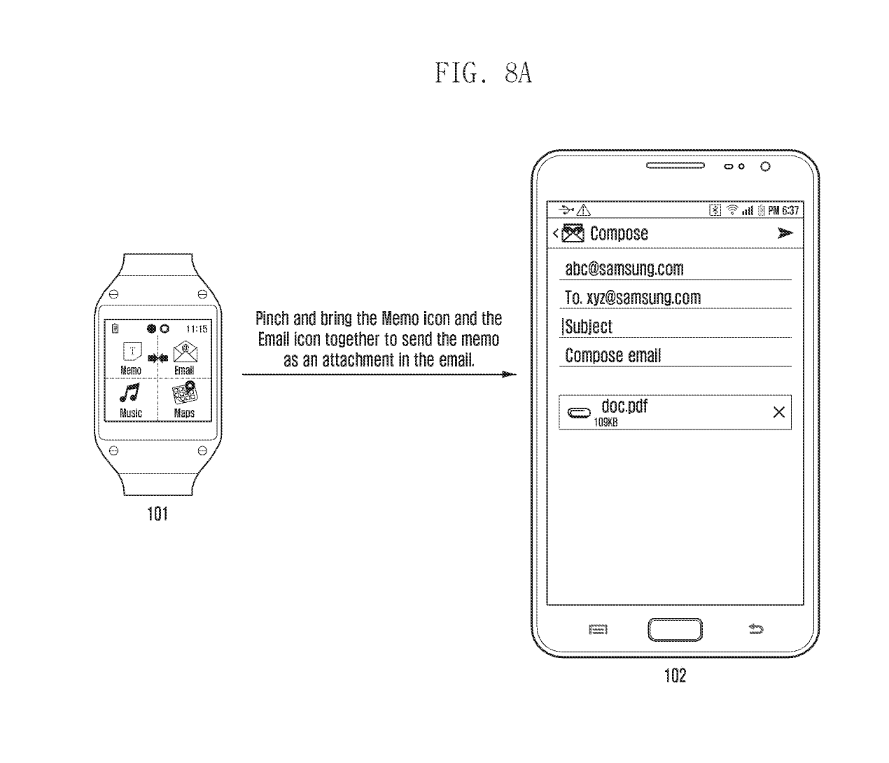

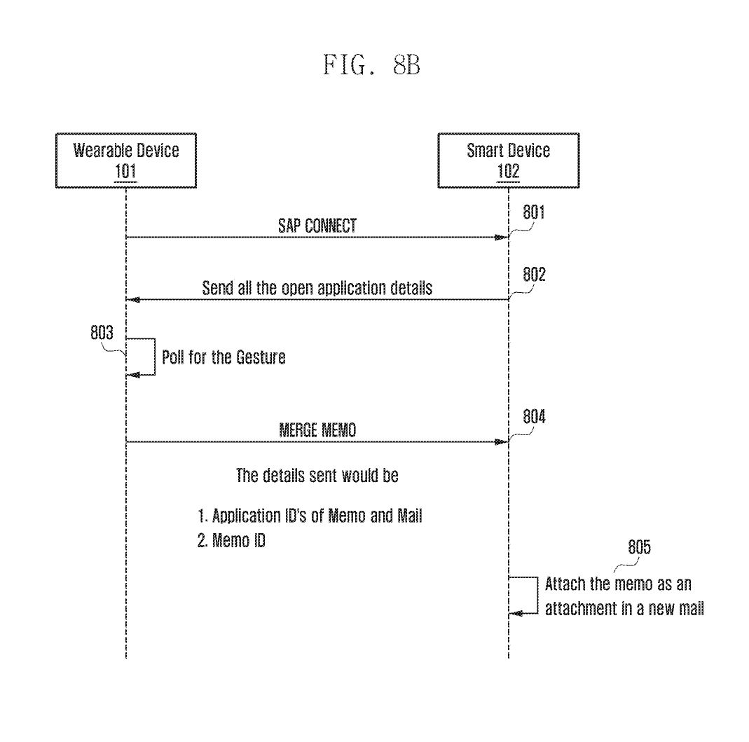

FIGS. 8A and 8B illustrate a scenario of transmitting a memo as an email attachment on receiving a predefined gesture on a wearable device according to an embodiment of the present disclosure. This is an embodiment of contextual merging of two different applications.

Referring to FIG. 8A, the memo is opened in a first priority quadrant and an email is opened in a second priority quadrant. A user provides a predefined gesture, such as pinching and brings the memo icon and the email icon together to transmit the memo as an attachment in the email. Thereafter, the memo is attached to an email by just a pinch gesture.

Referring to FIG. 8B, a flow diagram of a method of transmitting a memo as an email attachment on receiving a predefined gesture on a wearable device is illustrated according to an embodiment of the present disclosure. At operation 801, the wearable device 101 connects to the smart device 102 (such as a smart phone or a tablet) through SAP. Once the connection is established, the smart device 102 transmits all the open application details to the wearable device 101 at operation 802. At operation 803, the UI of the wearable device 101 receives a predefined gesture. Subsequently the wearable device 101 processes the gesture and provides the details to the smart device 102 at operation 804. The details include but not limited to applications IDs of memo and mail, and memo ID. At operation 805, the smart device 102 on receiving the details attaches the memo as an attachment in a new e-mail.

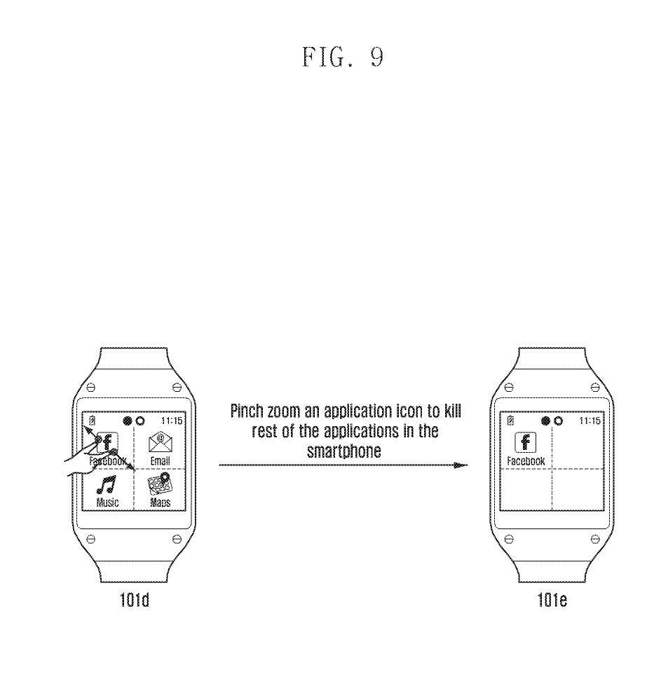

FIG. 9 illustrates a scenario of closing one or more applications on receiving a predefined gesture on a wearable device according to an embodiment of the present disclosure.

Referring to FIG. 9, this embodiment describes that the user can either close a particular application or all other applications open on the smart device excluding the particular application by pinch zooming on the particular application icon shown on the wearable device 101d. When the user provides a gesture on an icon of a particular application (such as Facebook in this particular example) displaying on the wearable device 101d, all the applications are closed except the Facebook application as shown in wearable device 101e.

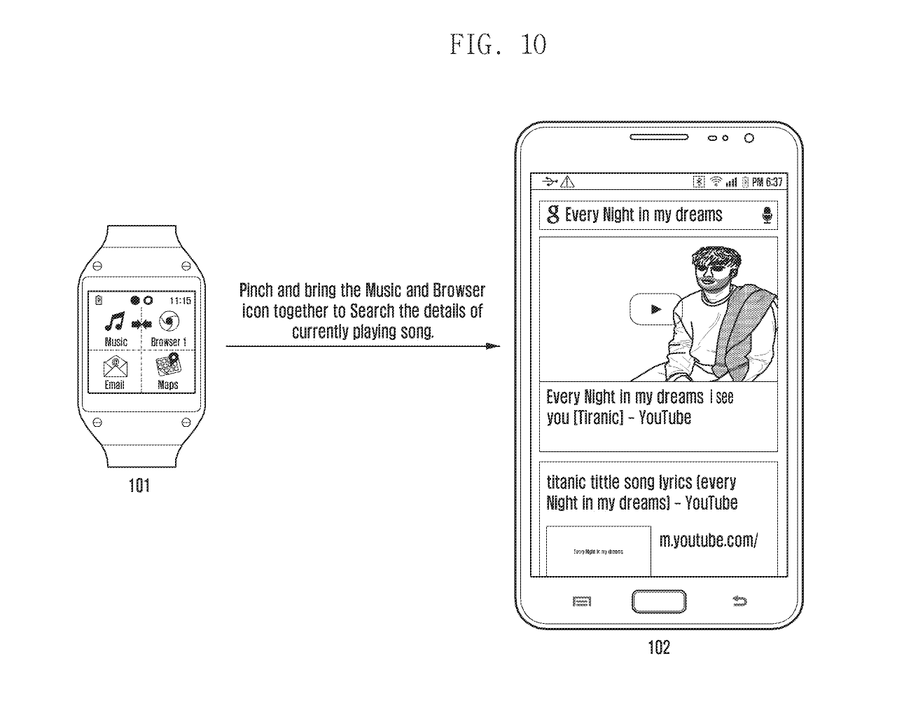

FIG. 10 illustrates a scenario of performing content based searching in a smart device on receiving a predefined gesture on a wearable device according to an embodiment of the present disclosure. This is further embodiment of contextual merging of two different applications running on the smart device 102.

Referring to FIG. 10, the icon of the music player (assuming currently some music being played) and the icon of the browser application can be pinched and brought together to merge them contextually which results in:

Extracting the Meta data from the music file.

Using some of the field in the Meta data as a search input to the browser.

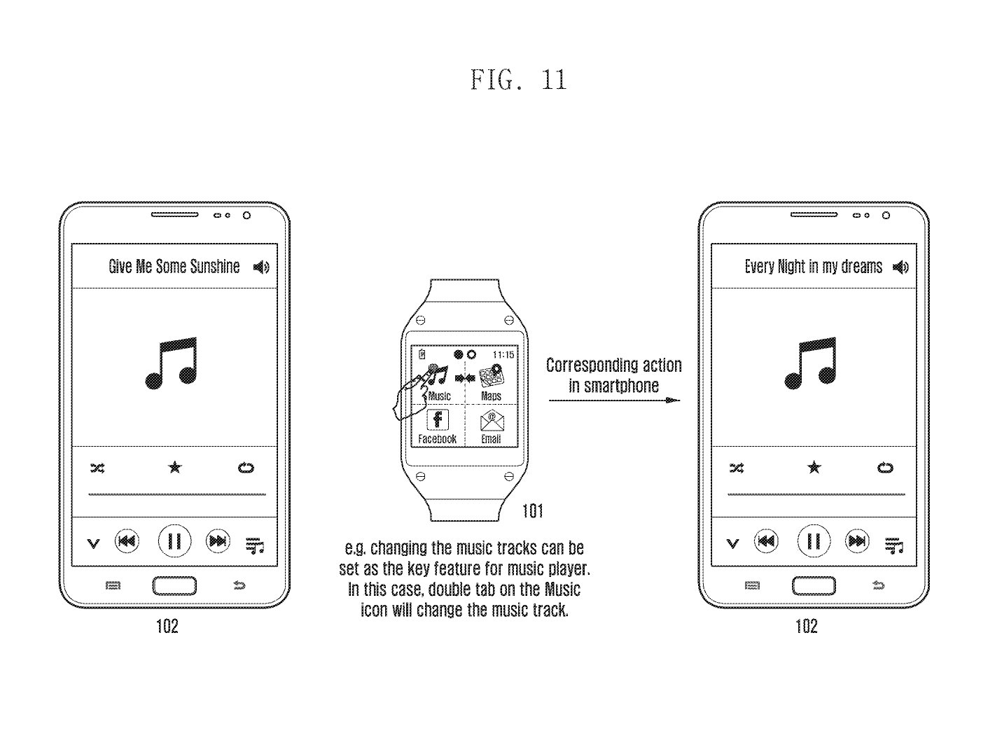

FIG. 11 illustrates a scenario of controlling key feature of an application in a smart device on receiving a predefined gesture on a wearable device according to an embodiment of the present disclosure. This embodiment describes how a basic feature of any application running on the smart device can be controlled by a predefined gesture (such as a double tap gesture) on its icon on the UI of the wearable device 101.

Referring to FIG. 11, following are few examples given below in respect of controlling basic feature of any application based on either user configuration or predefined configuration:
Double tapping on the music application icon switch the running music track to next track.
Double tapping on an email/social application triggers the sync.
Double tapping on the calendar application displays the next appointment.

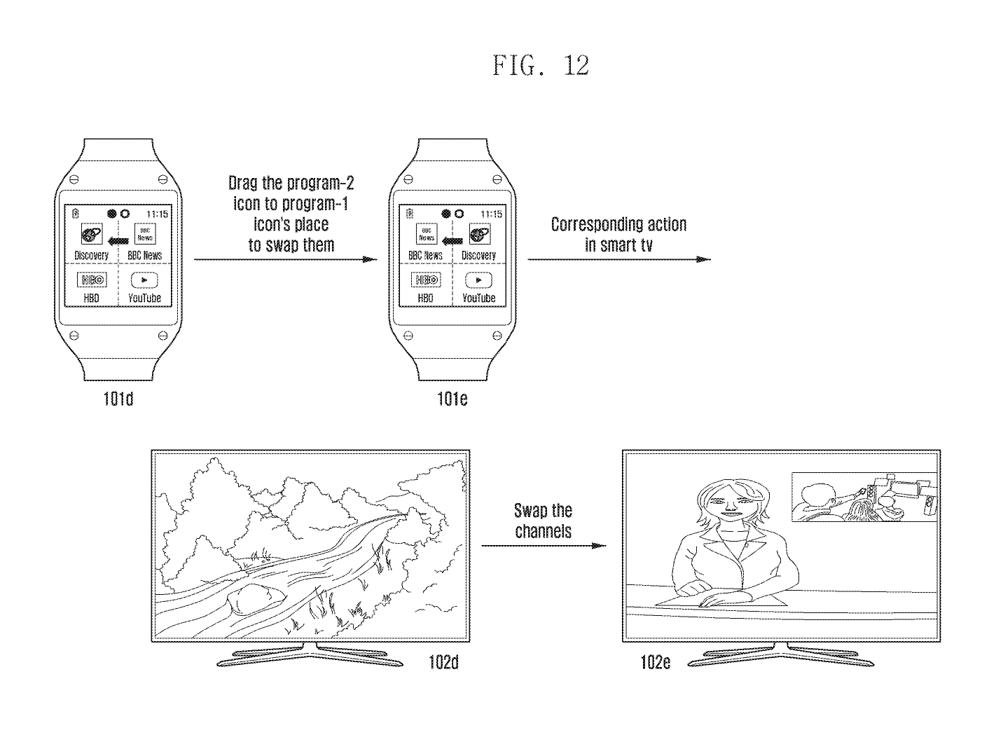

FIG. 12 illustrates a scenario of swapping two programs in a smart TV on receiving a predefined gesture on a wearable device according to an embodiment of the present disclosure. In this embodiment of the present disclosure, the wearable device wirelessly connects to the smart TV 102.

Referring to FIG. 12, the smart TV 102 shares the channel details and the settings of each channel with the wearable device 101. The screen of the wearable device 101 shows four channels one in each quadrant. The channel icon shown in the first priority quadrant (fourth quadrant of the screen) is displaying on the smart TV 102. The user can change the displaying channel by using a predefined gesture, such as dragging another channel's icon to the first priority quadrant. Once the UI receives the gesture, the wearable device 101 process the gesture and transmits the details to the smart TV 102. Then the smart TV 102 processes the details and changes the displaying channel.

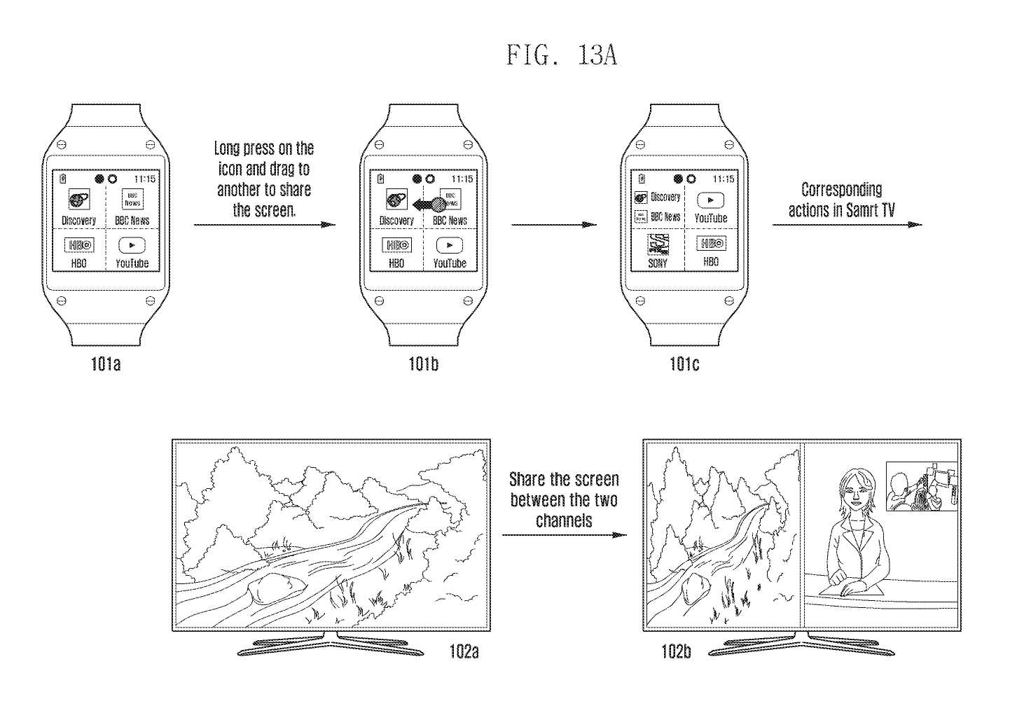

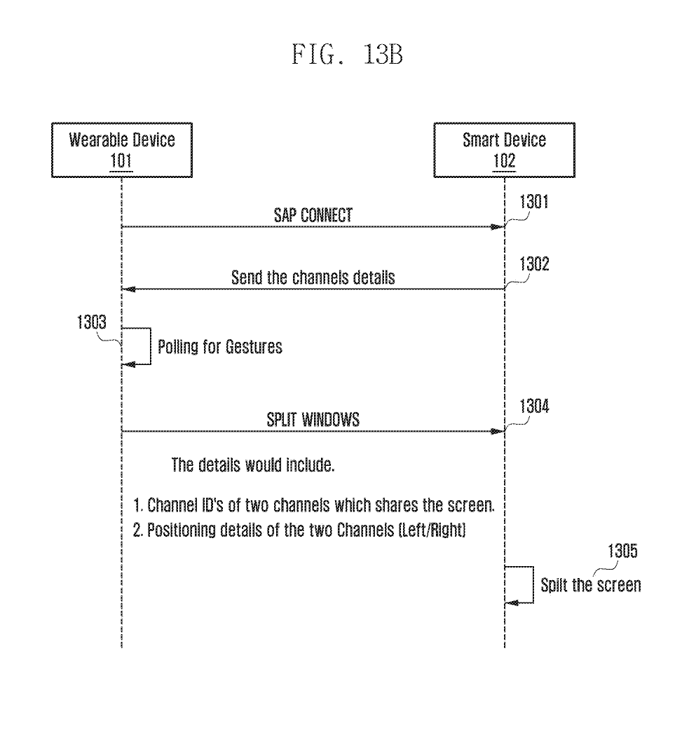

FIGS. 13A and 13B illustrate a scenario of sharing a display screen among multiple TV channels on receiving a predefined gesture on a wearable device according to an embodiment of the present disclosure.

Referring to FIG. 13A, a flow diagram of how to virtually split the TV screen to display two different channels on the same screen is illustrated. The smart TV 102a displays only one channel. When the user provides a predefined gesture on the wearable device 101a, the screen of the smart TV 102 is virtually split and displays two channels together on the same screen.

Referring to FIG. 13B, a flow diagram of a method of sharing a display screen among multiple TV channels on receiving a predefined gesture on a wearable device is illustrated, according to an embodiment of the present disclosure. At operation 1301, the wearable device connects to the smart TV through SAP. Once the connection is established, the smart TV 102 transmits the channel details to the wearable device 101 at operation 1302. At operation 1303, the wearable device 101 performs polling for a gesture and receives a predefined gesture on the UI provided by the user. Subsequently, the wearable device 101 processes the received gesture. Here, the polling is a procedure in which one process waits for the inputs from another. In this case, after receiving the channel details, the wearable device waits for the user gestures. This wait is described as polling. At operation 1304, the instruction along with the details is sent to the smart TV 102 to virtually split the display screen by the wearable device 101. The details include but not limited to channel IDs of two channel which shares the screen and positioning details of the two channels (such as left or right). At operation 1305, the display screen is virtually split and the two channels are displayed simultaneously.

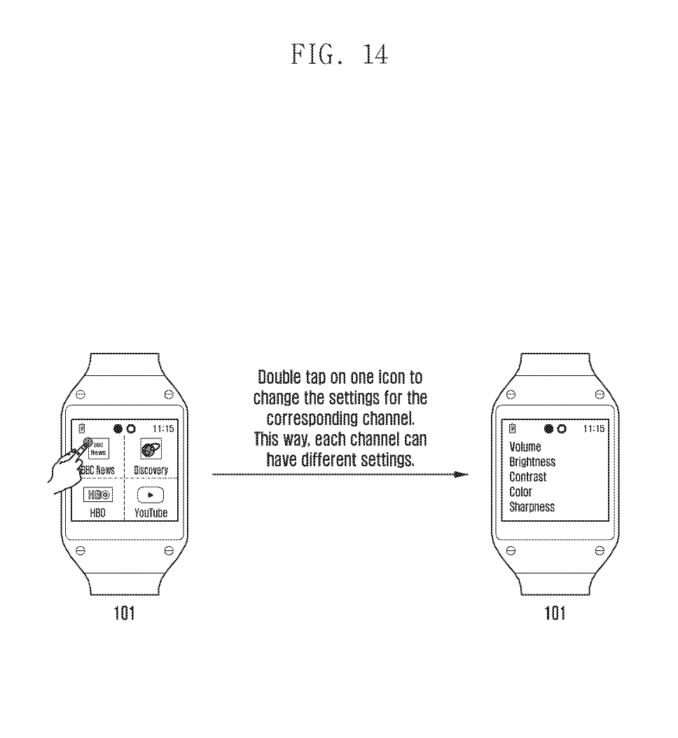

FIG. 14 illustrates a scenario of defining a specific setting for each channel using a wearable device according to an embodiment of the present disclosure.

Referring to FIG. 14, this embodiment describes that the setting of the smart TV 102 can be changed using one or more predefined gestures on the wearable device 101. For instance, whenever the user double taps the icon of a channel, the settings screen opens up wherein the user can configure the setting like volume, brightness, contrast, color, sharpness and screen dimensions for that particular channel alone. Once done, these settings are pushed to the smart TV 102. Until further changes, whenever this channel is played, the user configured settings are used in the smart TV 102.

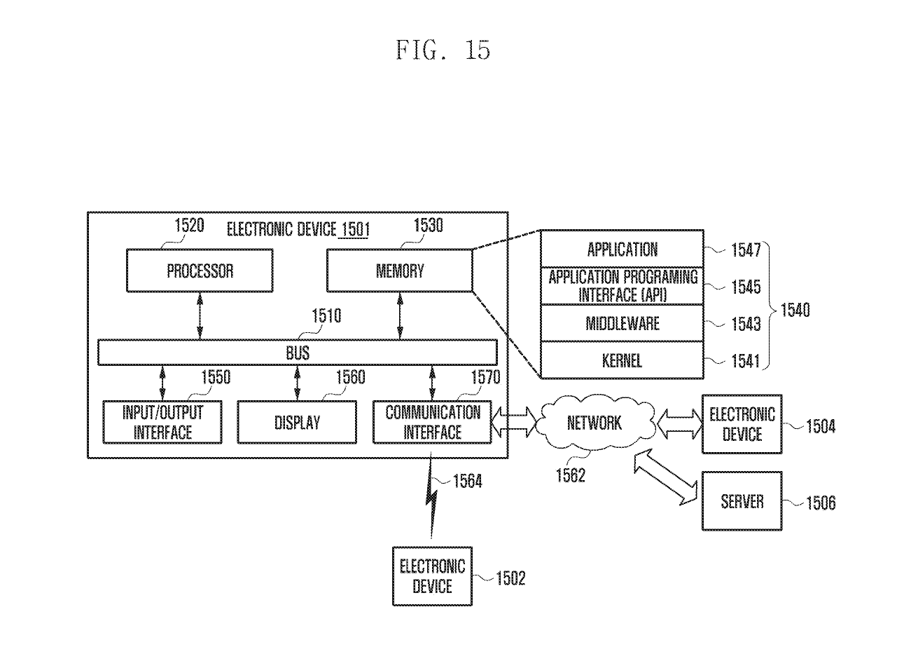

FIG. 15 is a block diagram illustrating a configuration of an electronic device according to an embodiment of the present disclosure.

Referring to FIG. 15, an electronic device 1501 may include a bus 1510, a processor 1520, a memory 1530, a user input module 1550, a display module 1560, a communication module 1570, and other similar and/or suitable components.

The bus 1510 may be a circuit which interconnects the above-described elements and delivers a communication (e.g., a control message) between the above-described elements.

The processor 1520 may receive commands from the above-described other elements (e.g., the memory 1530, the user input module 1550, the display module 1560, the communication module 1570, and the like) through the bus 1510, may interpret the received commands, and may execute calculation or data processing according to the interpreted commands.

The memory 1530 may store commands or data received from the processor 1520 or other elements (e.g., the user input module 1550, the display module 1560, the communication module 1570, and the like) or generated by the processor 1520 or the other elements. The memory 1530 may include programming modules 140, such as a kernel 1541, middleware 1543, an application programming interface (API) 1545, an application 1547, and the like. Each of the above-described programming modules may be implemented in software, firmware, hardware, or a combination of two or more thereof.

The kernel 1541 may control or manage system resources (e.g., the bus 1510, the processor 1520, the memory 1530, and the like) used to execute operations or functions implemented by other programming modules (e.g., the middleware 1543, the API 1545, and the application 1547). In addition, the kernel 1541 may provide an interface capable of accessing and controlling or managing the individual elements of the electronic device 1501 by using the middleware 1543, the API 1545, or the application 1547.

The middleware 1543 may serve to go between the API 1545 or the application 1547 and the kernel 1541 in such a manner that the API 1545 or the application 1547 communicates with the kernel 1541 and exchanges data therewith. In addition, in relation to work requests received from one or more applications 1547 and/or the middleware 1543, for example, may perform load balancing of the work requests by using a method of assigning a priority, in which system resources (e.g., the bus 1510, the processor 1520, the memory 1530, and the like) of the electronic device 1501 can be used, to at least one of the one or more applications 1547.

The API 1545 is an interface through which the application 1547 is capable of controlling a function provided by the kernel 1541 or the middleware 1543, and may include, for example, at least one interface or function for file control, window control, image processing, character control, and the like.

The user input module 1550, for example, may receive a command or data as input from a user, and may deliver the received command or data to the processor 1520 or the memory 1530 through the bus 1510. The display module 1560 may display a video, an image, data, and the like, to the user.

The communication module 1570 may connect communication between another electronic device 1502 and the electronic device 1501 through a wireless communication 1564. The communication module 1570 may support a certain short-range communication protocol (e.g., Wi-Fi, Bluetooth (BT), and near field communication (NFC)), or a network 1562 (e.g., the internet, a local area network (LAN), a wide area network (WAN), a telecommunication network, a cellular network, a satellite network, a plain old telephone service (POTS), and the like). Each of the electronic devices 1502 and 1504 may be a device which is identical (e.g., of an identical type) to or different (e.g., of a different type) from the electronic device 1501. Further, the communication module 1570 may connect communication between a server 1506 and the electronic device 1501 via the network 1562.

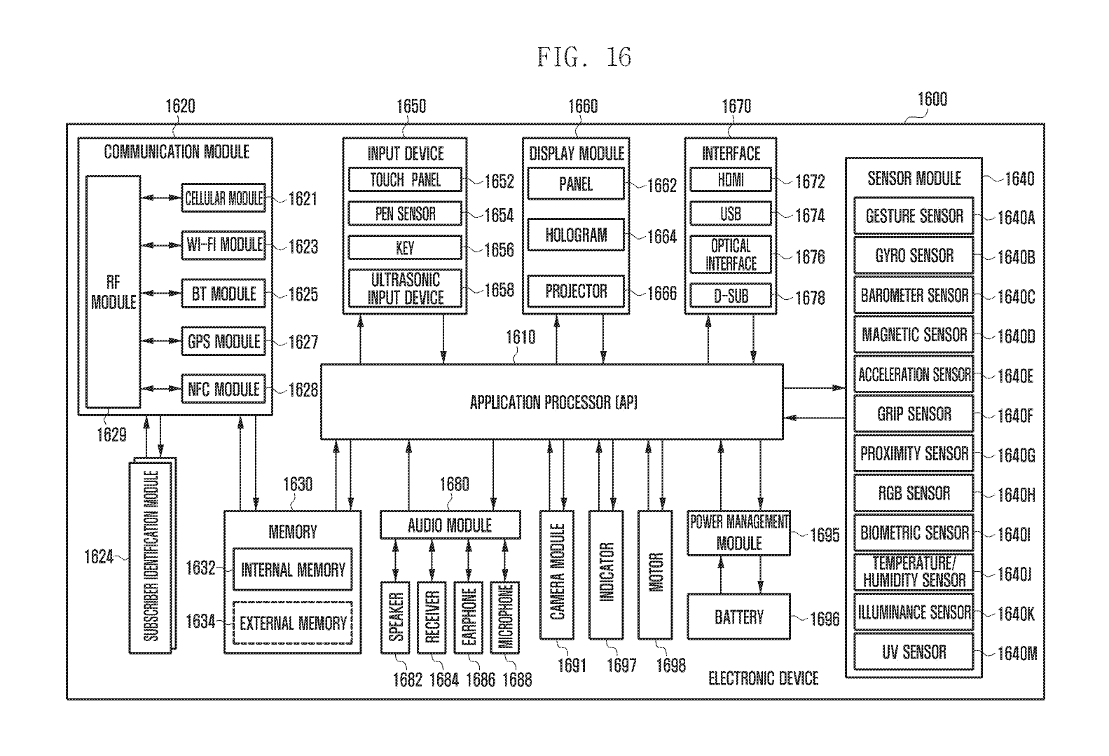

FIG. 16 is a block diagram illustrating an electronic device according to an embodiment of the present disclosure.

Referring to FIG. 16, a hardware 1600 may be, for example, the electronic device 1501 illustrated in FIG. 15, and may include one or more processors 1610, a subscriber identification module (SIM) card 1624, a memory 1630, a communication module 1620, a sensor module 1640, a user input module 1650, a display module 1660, an interface 1670, an audio coder/decoder (codec) 1680, a camera module 1691, a power management module 1695, a battery 1696, an indicator 1697, a motor 1698 and any other similar and/or suitable components.

The one or more processors 1610 (e.g., the processor 120) may include one or more application processors (APs) 1610, or one or more communication processors (CPs). The one or more processors 1610 may be, for example, the processor 1520 illustrated in FIG. 15. The AP 1610 and the CP are illustrated as being included in the one or more processors 1610 in FIG. 16, but may be included in different integrated circuit (IC) packages, respectively. According to an embodiment of the present disclosure, the AP 1610 and the CP may be included in one IC package.

The AP 1610 may execute an OS or an application program, and thereby may control multiple hardware or software elements connected to the AP 1610 and may perform processing of and arithmetic operations on various data including multimedia data. The AP 1610 may be implemented by, for example, a system on chip (SoC). According to an embodiment of the present disclosure, the one or more processors 1610 may further include a graphics processing unit (GPU) (not illustrated).

The CP may manage a data line and may convert a communication protocol in the case of communication between the electronic device (e.g., the electronic device 100) including the hardware 1600 and different electronic devices connected to the electronic device through the network. The CP may be implemented by, for example, an SoC. According to an embodiment of the present disclosure, the CP may perform at least some of multimedia control functions. The CP, for example, may distinguish and authenticate a terminal in a communication network by using a subscriber identification module (e.g., the SIM card 1614). In addition, the CP may provide the user with services, such as a voice telephony call, a video telephony call, a text message, packet data, and the like.

Further, the CP may control the transmission and reception of data by the communication module 1620. In FIG. 16, the elements, such as the CP, the power management module 1695, the memory 1630, and the like, are illustrated as elements separate from the AP 1610. However, according to an embodiment of the present disclosure, the AP 1610 may include at least some (e.g., the CP) of the above-described elements.

According to an embodiment of the present disclosure, the AP 1610 or the CP may load, to a volatile memory, a command or data received from at least one of a non-volatile memory and other elements connected to each of the AP 1610 and the CP, and may process the loaded command or data. In addition, the AP 1610 or the CP may store, in a non-volatile memory, data received from or generated by at least one of the other elements.

The SIM card 1614 may be a card implementing a subscriber identification module, and may be inserted into a slot formed in a particular portion of the electronic device 100. The SIM card 1614 may include unique identification information (e.g., IC card identifier (ICCID)) or subscriber information (e.g., international mobile subscriber identity (IMSI)).

The memory 1630 may include an internal memory 1632 and an external memory 1634. The memory 1630 may be, for example, the memory 1530 illustrated in FIG. 15. The internal memory 1632 may include, for example, at least one of a volatile memory (e.g., a dynamic random access memory (DRAM), a static RAM (SRAM), a synchronous DRAM (SDRAM), and the like), and a non-volatile memory (e.g., a one-time programmable read only memory (OTPROM), a PROM, an erasable and programmable ROM (EPROM), an electrically erasable and programmable ROM (EEPROM), a mask ROM, a flash ROM, a NAND flash memory, a NOR flash memory, and the like). According to an embodiment of the present disclosure, the internal memory 1632 may be in the form of a solid state drive (SSD). The external memory 1634 may further include a flash drive, for example, a compact flash (CF), a secure digital (SD), a micro-SD, a mini-SD, an extreme digital (xD), a memory stick, and the like.

The communication module 1620 may include a wireless communication module 1621 or a radio frequency (RF) module 1629. The communication module 1620 may be, for example, the communication module 1570 illustrated in FIG. 15. The wireless communication module 1621 may include, for example, a Wi-Fi module 1623, a BT module 1625, a GPS module 1627, or an NFC module 1628. For example, the wireless communication module 1621 may provide a wireless communication function by using a radio frequency. Additionally or alternatively, the wireless communication module 1621 may include a network interface (e.g., a LAN card), a modulator/demodulator (modem), and the like, for connecting the hardware 1600 to a network (e.g., the internet, a LAN, a WAN, a telecommunication network, a cellular network, a satellite network, a POTS, and the like).

The RF module 1629 may be used for transmission and reception of data, for example, transmission and reception of RF signals or called electronic signals. Although not illustrated, the RF unit 1629 may include, for example, a transceiver, a power amplifier module (PAM), a frequency filter, a low noise amplifier (LNA), and the like. In addition, the RF module 1629 may further include a component for transmitting and receiving electromagnetic waves in a free space in a wireless communication, for example, a conductor, a conductive wire, and the like.

The sensor module 1640 may include, for example, at least one of a gesture sensor 1640A, a gyro sensor 1640B, an atmospheric pressure sensor 1640C, a magnetic sensor 1640D, an acceleration sensor 1640E, a grip sensor 1640F, a proximity sensor 1640G, a red, green and blue (RGB) sensor 1640H, a biometric sensor 1640I, a temperature/humidity sensor 1640J, an illuminance sensor 1640K, and an ultra violet (UV) sensor 1640M. The sensor module 1640 may measure a physical quantity or may detect an operating state of the electronic device 100, and may convert the measured or detected information to an electrical signal. Additionally/alternatively, the sensor module 1640 may include, for example, an E-nose sensor (not illustrated), an electromyography (EMG) sensor (not illustrated), an electroencephalogram (EEG) sensor (not illustrated), an electrocardiogram (ECG) sensor (not illustrated), a fingerprint sensor (not illustrated), and the like. Additionally or alternatively, the sensor module 1640 may include, for example, an E-nose sensor (not illustrated), an EMG sensor (not illustrated), an EEG sensor (not illustrated), an ECG sensor (not illustrated), a fingerprint sensor, and the like. The sensor module 1640 may further include a control circuit (not illustrated) for controlling one or more sensors included therein.

The user input module 1650 may include a touch panel 1652, a pen sensor 1654 (e.g., a digital pen sensor), keys 1656, and an ultrasonic input unit 1658. The user input module 1650 may be, for example, the user input module 1550 illustrated in FIG. 15. The touch panel 1652 may recognize a touch input in at least one of, for example, a capacitive scheme, a resistive scheme, an infrared scheme, and an acoustic wave scheme. In addition, the touch panel 1652 may further include a controller (not illustrated). In the capacitive type, the touch panel 1652 is capable of recognizing proximity as well as a direct touch. The touch panel 1652 may further include a tactile layer (not illustrated). In this event, the touch panel 1652 may provide a tactile response to the user.

The pen sensor 1654 (e.g., a digital pen sensor), for example, may be implemented by using a method identical or similar to a method of receiving a touch input from the user, or by using a separate sheet for recognition. For example, a key pad or a touch key may be used as the keys 1656. The ultrasonic input unit 1658 enables the terminal to detect a sound wave by using a microphone (e.g., a microphone 1688) of the terminal through a pen generating an ultrasonic signal, and to identify data. The ultrasonic input unit 1658 is capable of wireless recognition. According to an embodiment of the present disclosure, the hardware 1600 may receive a user input from an external device (e.g., a network, a computer, or a server), which is connected to the communication module 1620, through the communication module 1620.

The display module 1660 may include a panel 1662 or a hologram 1664. The display module 1660 may be, for example, the display module 1560 illustrated in FIG. 15. The panel 1662 may be, for example, a liquid crystal display (LCD) and an active matrix organic light emitting diode (AM-OLED) display, and the like. The panel 1662 may be implemented so as to be, for example, flexible, transparent, or wearable. The panel 1662 may include the touch panel 1652 and one module. The hologram 1664 may display a three-dimensional image in the air by using interference of light. According to an embodiment of the present disclosure, the display module 1660 may further include a control circuit for controlling the panel 1662 or the hologram 1664.

The interface 1670 may include, for example, a high-definition multimedia interface (HDMI) 1672, a universal serial bus (USB) 1674, a projector 1676, and a D-subminiature (D-sub) 1678. Additionally or alternatively, the interface 1670 may include, for example, SD/multi-media card (MMC) (not illustrated) or infrared data association (IrDA) (not illustrated).

The audio codec 1680 may bidirectionally convert between a voice and an electrical signal. The audio codec 1680 may convert voice information, which is input to or output from the audio codec 1680, through, for example, a speaker 1682, a receiver 1684, an earphone 1686, the microphone 1688, and the like.

The camera module 1691 may capture an image and a moving image. According to an embodiment of the present disclosure, the camera module 1691 may include one or more image sensors (e.g., a front lens or a back lens), an image signal processor (ISP) (not illustrated), and a flash LED (not illustrated).

The power management module 1695 may manage power of the hardware 1600. Although not illustrated, the power management module 1695 may include, for example, a power management IC (PMIC), a charger IC, or a battery fuel gauge.

The PMIC may be mounted to, for example, an IC or an SoC semiconductor. Charging methods may be classified into a wired charging method and a wireless charging method. The charger IC may charge a battery, and may prevent an overvoltage or an overcurrent from a charger to the battery. According to an embodiment of the present disclosure, the charger IC may include a charger IC for at least one of the wired charging method and the wireless charging method. Examples of the wireless charging method may include a magnetic resonance method, a magnetic induction method, an electromagnetic method, and the like. Additional circuits (e.g., a coil loop, a resonance circuit, a rectifier, and the like) for wireless charging may be added in order to perform the wireless charging.

The battery fuel gauge may measure, for example, a residual quantity of the battery 1696, or a voltage, a current or a temperature during the charging. The battery 1696 may supply power by generating electricity, and may be, for example, a rechargeable battery.

The indicator 1697 may indicate particular states of the hardware 1600 or a part (e.g., the AP 1610) of the hardware 1600, for example, a booting state, a message state, a charging state and the like. The motor 1698 may convert an electrical signal into a mechanical vibration. The one or more processors 1610 may control the sensor module 1640.

Although not illustrated, the hardware 1600 may include a processing unit (e.g., a GPU) for supporting a module TV. The processing unit for supporting a module TV may process media data according to standards such as, for example, digital multimedia broadcasting (DMB), digital video broadcasting (DVB), media flow, and the like. Each of the above-described elements of the hardware 1600 according to an embodiment of the present disclosure may include one or more components, and the name of the relevant element may change depending on the type of electronic device. The hardware 1600 according to an embodiment of the present disclosure may include at least one of the above-described elements. Some of the above-described elements may be omitted from the hardware 1600, or the hardware 1600 may further include additional elements. In addition, some of the elements of the hardware 1600 according to an embodiment of the present disclosure may be combined into one entity, which may perform functions identical to those of the relevant elements before the combination.

An electronic device according to various embodiments of the present disclosure may include a touch screen, a memory, and a processor electrically connected to the display and the memory. The memory may store instructions that allow the processor, at the time of execution, to control at least one icon that corresponds to at least one application being executed by an external electronic device or corresponds to a notification to be displayed on the touch screen according to a priority order, and transmit, to the external electronic device, a command to allow the external electronic device to perform an event associated with an application or notification corresponding to an icon having received the touch gesture, in response to a touch gesture received by one or more icons of the at least one icon. For example, the electronic device may display an icon corresponding to an application being executed by the external electronic device, a notification received by the external electronic device, a channel being displayed by the external electronic device, and the like.

According to an embodiment of the present disclosure, the electronic device may be a wearable device. According to an embodiment of the present disclosure, the external electronic device may be a smart device (e.g., a cellular phone, a tablet, a smart TV, and the like) connected with the electronic device.

According to various embodiments of the present disclosure, the touch gesture may include at least one of swapping and tapping, pinching and bringing multiple icons together, pinching and zooming an icon, tapping an icon twice, and dragging an icon in a direction of another icon after pressing the icon during a certain time.

According to various embodiments of the present disclosure, the event may include changing a priority order with respect to an application or notification corresponding to an icon having received the touch gesture in response to the touch gesture. The event may include converting an application corresponding to an icon having received the touch gesture into one of a foreground application and a background application.

According to various embodiments of the present disclosure, the at least one icon may include a first icon corresponding to a first call received by the external electronic device from outside and a second icon corresponding to a second call. In this case, the event may include changing a priority order of the first call and the second call such that one of the first call and the second call is picked up and the other maintains an on-hold state, in response to a touch gesture received by the first icon or the second icon.

According to various embodiments of the present disclosure, the event may include combining the first call and the second call into a single conference call, in response to a touch gesture received by the first icon and the second icon.

According to various embodiments of the present disclosure, the event may include terminating an application corresponding to another icon except for an icon having received the touch gesture. According to various embodiments of the present disclosure, the event may include terminating an application corresponding to an icon having received the touch gesture.

According to various embodiments of the present disclosure, the event may include performing a function configured for each application, by an application corresponding to an icon having received the touch gesture. For example, a music reproduction application may reproduce a following song in response to a touch gesture. For example, an image reproduction application or a TV broadcasting application may display a configuration menu in response to a touch gesture. Additional various embodiments are possible.

According to various embodiments of the present disclosure, the event may include dividing, by the external electronic device, a screen so as to display screens of multiple applications together, which correspond to multiple icons having received the touch gesture. For example, the event may be displaying, together, an execution screen of an application being executed by an external electronic device in the current foreground and an execution screen of an application corresponding to an icon having received a touch gesture.

According to various embodiments of the present disclosure, when the external electronic device is a smart TV, the at least one icon may include an icon corresponding to a channel of the smart TV, and the event may include at least one of changing a channel displayed by the smart TV, dividing a screen of the smart TV to display multiple channels, and changing a channel configuration of the smart TV. For example, an electronic device may transmit, to an external electronic device, a command for performing an event configured according to a received touch gesture.

According to various embodiments of the present disclosure, the at least one icon may include a first icon and a second icon, and the event may include extracting information relating to a first application corresponding to the first icon, in response to a touch gesture received by the first icon and the second icon, and apply the extracted information to a second application corresponding to the second icon so as to provide a function of the second application. For example, when a first application is a memo application and a second application is an email application, an electronic device may transmit, to an external electronic device, a command to attach a memo file created by the memo application to the email application. For example, when a first application is a first browser and a second application is a second browser, an electronic device may open a tab (e.g., a web page) that has been opened in the first browser, in the second browser as well, and transmit a command to terminate the first browser to an external electronic device. For example, when a first application is a content (e.g., video or audio) reproduction application and a second application is a browser (a search function application), an electronic device may transmit, to an external electronic device, a command to search for information relating to a content being reproduced by the first application, through the second application.

An operation method for an electronic device according to various embodiments of the present disclosure may include the operations of: displaying, on a touch screen of the electronic device, at least one icon which corresponds to at least one application being executed by an external electronic device or corresponds to a notification, according to a priority order; and transmitting, to the external electronic device connected with the electronic device, a command to allow the external electronic device to perform an event associated with an application or notification corresponding to an icon having received a touch gesture, in response to the touch gesture received by one or more icons of the at least one icon.

According to various embodiments of the present disclosure, the event may include at least one of: changing a priority order with respect to an application or notification corresponding to an icon having received the touch gesture, in response to the touch gesture; converting an application corresponding to an icon having received the touch gesture into one of a foreground application and a background application; changing a priority order of an application or notification corresponding to multiple icons having received the touch gesture; combining at least two reception calls corresponding to multiple icons having received the touch gesture into a conference call; terminating an application corresponding to another icon except for an icon having received the touch gesture; performing a function configured for each application, by an application corresponding to an icon having received the touch gesture; dividing a screen so as to display screens of multiple applications together, which correspond to multiple icons having received the touch gesture; and extracting information relating to a first application corresponding to one of the at least one icon, in response to the touch gesture, and applying the extracted information to a second application corresponding to another one of the at least one icon, so as to provide a function of the second application.

The term “module” used in the present disclosure may refer to, for example, a unit including one or more combinations of hardware, software, and firmware. The “module” may be interchangeable with a term, such as “unit,” “logic,” “logical block,” “component,” “circuit,” and the like. The “module” may be a minimum unit of a component formed as one body or a part thereof. The “module” may be a minimum unit for performing one or more functions or a part thereof. The “module” may be implemented mechanically or electronically. For example, the “module” according to an embodiment of the present disclosure may include at least one of an application-specific IC (ASIC) chip, a field-programmable gate array (FPGA), and a programmable-logic device for performing certain operations which have been known or are to be developed in the future.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. A method for managing applications running on a smart device, the method comprising:
displaying a plurality of application icons on a wearable device, wherein each icon from the plurality of application icons represents an active application on the smart device connected to the wearable device;
receiving a touch gesture on one or more application icons of the plurality of application icons; and
triggering the smart device to perform an event comprising an interaction between the active applications represented by the one or more application icons in response to the touch gesture.

2. The method of claim 1, wherein triggering the smart device to perform an event comprises switching control feature between an application mode and a priority mode on receiving the touch gesture.

3. The method of claim 2, wherein the application mode is used to transmit one or more of the active applications to one of a foreground application and a background application of the smart device.

4. The method of claim 3, wherein the priority mode is used to assign user priority to the one or more active applications based on predefined instruction.

5. The method of claim 4, wherein hardware and software resources of the smart device are shared among the active applications based on the priority assigned by the user, wherein a top priority application gets more resources compared to a relatively lower priority application.

6. The method of claim 1, wherein the touch gesture, for triggering the smart device to perform an event, comprises at least one of:
pinching and bringing icons of a first incoming call and a second incoming call together to merge both the calls into a conference call;
pressing an icon for a predefined period and dragging to a first priority quadrant of a display of the wearable device to split screen of the smart device;
pinching and bringing icons of two browsers displaying on two priority quadrants together in one of a priority quadrant to open all the tabs in one browser on the smart device and close the other browser based on predefined instruction;
pinching and bringing icons of a memo application and an email application together to transmit the memo as an attachment in an e-mail of the email application;
pinching and zooming an application icon to terminate one or more remaining active applications in the smart device;
pinching and bringing icons of a music icon and web browser together to search details of a currently playing song on the web browser;
tapping twice on the music icon displaying on one of the priority quadrant for changing the music tracks running on the smart device;
dragging a program icon to the first priority quadrant to change a running program on a smart television (TV);
pressing a program icon for a predefined period and dragging to the first priority quadrant to split display screen of a smart TV; and
tapping twice on an icon of a TV channel for opening channel settings thereby allowing user to change the channel settings,
wherein a display of the smart device is divided into at least four priority quadrants representing the first priority quadrant, a second priority quadrant, a third priority quadrant, and a fourth priority quadrant.

7. The method of claim 1, wherein the two or more active applications on the smart device are merged based on receiving a predefined gesture on the wearable device to perform one or more functions on the smart device based on predefined configuration.

8. An electronic device comprising:
a touch screen;
a memory; and
a processor electrically connected to the touch screen and the memory, wherein the memory is configured to store instructions that allow the processor, at the time of execution, to:
control at least one icon that:
corresponds to at least one application being executed by an external electronic device, or
corresponds to a notification to be displayed on the touch screen according to a priority order, and
transmit, to the external electronic device, a command configured to perform, by the external electronic device, an event associated with the application or the notification corresponding to an icon having received a touch gesture, in response to the touch gesture received by one or more icons of at least one icon.

9. The electronic device of claim 8, wherein the touch gesture comprises at least one of swapping and tapping, pinching and bringing multiple icons together, pinching and zooming an icon, tapping an icon twice, and dragging an icon in a direction of another icon after pressing the icon during a certain time.

10. The electronic device of claim 8, wherein the event comprises changing a priority order with respect to an application or notification corresponding to an icon having received the touch gesture, in response to the touch gesture.

11. The electronic device of claim 8, wherein the event comprises converting an application corresponding to an icon having received the touch gesture into one of a foreground application and a background application.

12. The electronic device of claim 8,
wherein the at least one icon comprises a first icon corresponding to a first call received by the external electronic device from outside and a second icon corresponding to a second call, and
wherein the event comprises changing a priority order of the first call and the second call such that one of the first call and the second call is picked up and the other maintains an on-hold state, in response to a touch gesture received by the first icon or the second icon.

13. The electronic device of claim 8, wherein the event comprises combining the first call and the second call into a single conference call, in response to a touch gesture received by the first icon and the second icon.

14. The electronic device of claim 8, wherein the event comprises terminating an application corresponding to another icon except for an icon having received the touch gesture.

15. The electronic device of claim 8, wherein the event comprises performing a function configured for each application, by an application corresponding to an icon having received the touch gesture.

16. The electronic device of claim 8, wherein the event comprises dividing, by the external electronic device, a screen so as to display screens of multiple applications together, which correspond to multiple icons having received the touch gesture.

17. The electronic device of claim 8,
wherein, when the external electronic device comprises a smart television (TV), the at least one icon comprises an icon corresponding to a channel of the smart TV, and
wherein the event comprises at least one of changing a channel displayed by the smart TV, dividing a screen of the smart TV to display multiple channels, and changing a channel configuration of the smart TV.

18. The electronic device of claim 8,
wherein the at least one icon comprises a first icon and a second icon, and
wherein the event comprises:
extracting information relating to a first application corresponding to the first icon, in response to a touch gesture received by the first icon and the second icon, and
applying the extracted information to a second application corresponding to the second icon so as to provide a function of the second application.

19. A method for an electronic device, the method comprising:
displaying, on a touch screen of the electronic device, at least one icon that corresponds to at least one application being executed by an external electronic device or corresponds to a notification, according to a priority order; and
transmitting, to the external electronic device connected with the electronic device, a command to allow the external electronic device to perform an event associated with an application or notification corresponding to an icon having received a touch gesture, in response to the touch gesture received by one or more icons of the at least one icon.

20. The method of claim 19, wherein the event comprises at least one of:
changing a priority order with respect to an application or notification corresponding to an icon having received the touch gesture, in response to the touch gesture;
converting an application corresponding to an icon having received the touch gesture into one of a foreground application and a background application;
changing a priority order of an application or notification corresponding to multiple icons having received the touch gesture;
combining at least two reception calls corresponding to multiple icons having received the touch gesture into a conference call;
terminating an application corresponding another icon except for an icon having received the touch gesture;
performing a function configured for each application, by an application corresponding to an icon having received the touch gesture;
dividing a screen so as to display screens of multiple applications together, which correspond to multiple icons having received the touch gesture; and
extracting information relating to a first application corresponding to an icon of the at least one icon, in response to the touch gesture, and applying the extracted information to a second application corresponding to another one of the at least one icon so as to provide a function of the second application.
